(19) United States
(12) Patent Application Publication
(10) Pub. No.: US 2004/0025732 A1
(43) Pub. Date: Feb. 12, 2004

(54) Field electron emission materials and devices

(76) Inventors: Richard Allan Tuck, Berkshire (GB); Adrian Paul Burden, Oxfordshire (GB); Christopher Hood, Berkshire (GB); Warren Lee, Berkshire (GB); Michael Stuart Waite, Cheshire (GB); Mohan Edirisinghe, London (GB)

Correspondence Address: Lee Mann Smith McWilliams Sweeney & Ohlson, P O Box 2786, Chicago, IL, 60690-2786, US

(21) Appl. No.: 10/333,535

(22) PCT Filed: Jun. 28, 2001
(86) PCT No.: PCT/GB01/02862

(30) Foreign Application Priority Data
Jun. 30, 2000 (GB) 0015928.5

(51) Int. Cl. B41C 1/00; B41M 1/00

(52) U.S. Cl. 101/483

(57) ABSTRACT

To create a field electron emission material, there is printed upon a substrate (1501) an ink (1503) comprising a major component of fluid vehicle; a first minor component of electrically insulating material, either on its own or provided within a precursor therefor; and a second minor component of electrically conductive particles (1504). The printed ink is then treated to expel the major component and create the field electron emission material from the minor components on the substrate. The electrically conductive particles may be omitted, to print a solid, electrically insulating layer in a field emission device.

This invention relates to field electron emission materials, and devices using such materials.

In classical field electron emission, a high electric field of, for example, ≈3×10⁹ V m⁻¹ at the surface of a material reduces the thickness of the surface potential barrier to a point at which electrons can leave the material by quantum mechanical tunnelling. The necessary conditions can be realised using atomically sharp points to concentrate the macroscopic electric field. The field electron emission current can be further increased by using a surface with a low work function. The metrics of field electron emission are described by the well-known Fowler-Nordheim equation.

There is considerable prior art relating to tip based emitters, which term describes electron emitters and emitting arrays which utilise field electron emission from sharp points (tips). The main objective of workers in the art has been to place an electrode with an aperture (the gate) less than 1 μm away from each single emitting tip, so that the required high fields can by achieved using applied potentials of 100V or less—these emitters are termed gated arrays. The first practical realisation of this was described by C A Spindt, working at Stanford Research Institute in California (J.Appl.Phys. 39,7, pp 3504-3505, (1968)). Spindt's arrays used molybdenum emitting tips which were produced, using a self masking technique, by vacuum evaporation of metal into cylindrical depressions in a SiO₂ layer on a Si substrate.

In the 1970s, an alternative approach to produce similar structures was the use of directionally solidified eutectic alloys (DSE). DSE alloys have one phase in the form of aligned fibres in a matrix of another phase. The matrix can be etched back leaving the fibres protruding. After etching, a gate structure is produced by sequential vacuum evaporation of insulating and conducting layers. The build up of evaporated material on the tips acts as a mask, leaving an annular gap around a protruding fibre.

An important approach is the creation of gated arrays using silicon micro-engineering. Field electron emission displays utilising this technology are being manufactured at the present time, with interest by many organisations world-wide.

Major problems with all tip-based emitting systems are their vulnerability to damage by ion bombardment, ohmic heating at high currents and the catastrophic damage produced by electrical breakdown in the device. Making large area devices is both difficult and costly.

In about 1985, it was discovered that thin films of diamond could be grown on heated substrates from a hydrogen-methane atmosphere, to provide broad area field emitters—that is, field emitters that do not require deliberately engineered tips.

In 1991, it was reported by Wang et al (Eletron. Lett., 27, pp 1459-1461 (1991)) that field electron emission current could be obtained from broad area diamond films with electric fields as low as 3 MV m⁻¹. This performance is believed by some workers to be due to a combination of the low electron affinity of the (111) facets of diamond and the high density of localised, accidental graphite inclusions (Xu, Latham and Tzeng. Electron. Lett., 29, pp 1596-159(1993)) although other explanations are proposed.

Coatings with a high diamond content can now be grown on room temperature substrates using laser ablation and ion beam techniques. However, all such processes utilise expensive capital equipment and the performance of the materials so produced is unpredictable.

SI Diamond in the USA has described a field electron emission display (FED) that uses as the electron source a material that it calls Amorphic Diamond. The diamond coating technology is licensed from the University of Texas. The material is produced by laser ablation of graphite onto a substrate.

From the 1960s onwards another group of workers has been studying the mechanisms associated with electrical breakdown between electrodes in vacuum. It is well known (Latham and Xu, Vacuum, 42, 18, pp 1173-1181 (1991)) that as the voltage between electrodes is increased no current flows until a critical value is reached at which time a small noisy current starts flowing. This current increases both monotonically and stepwise with electric field until another critical value is reached, at which point it triggers an arc. It is generally understood that the key to improving voltage hold-off is the elimination of the sources of these pre-breakdown currents. Current understanding shows that the active sites are metal-insulator-vacuum (MIV) structures formed by either embedded dielectric particles or conducting flakes sitting on insulating patches such as the surface oxide of the metal. In both cases, the current comes from a hot electron process that accelerates the electrons resulting in quasi-thermionic emission over the surface potential barrier. This is well described in the scientific literature e.g. Latham, High Voltage Vacuum Insulation, Academic Press (1995). Although the teachings of this work have been adopted by a number of technologies (e.g. particle accelerators) to improve vacuum insulation, until recently little work has been done to create field electron emitters using the knowledge.

Latham and Mousa (J. Phys.D: Appl. Phys. 19, pp 699-713 (1986)) describe composite metal-insulator tip-based emitters using the above hot electron process and in 1988 S Bajic and R V Latham (Journal of Physics D Applied Physics, vol. 21 200-204 (1988)), described a composite that created a high density of metal-insulator-metal-insulator-vacuum (MIMIV) emitting sites. The composite had conducting particles dispersed in an epoxy resin. The coating was applied to the surface by standard spin coating techniques.

Much later in 1995 Tuck, Taylor and Latham (GB 2 304 989) improved the above MIMIV emitter by replacing the epoxy resin with an inorganic insulator that both improved stability and enabled it to be operated in sealed off vacuum devices. In 1997 Tuck and Bishop (GB 2 332 089) described electron emitters using metal-insulator-vacuum (MIV) emitter sites.

Embodiments of the present invention aim to provide inks for use in creating broad area field emitting materials, that maybe printed by means of silk screen, offset lithography and other techniques.

Preferred embodiments of the present invention aim to provide cost-effective broad area field emitting materials and devices that maybe used in devices that include (amongst others): field electron emission display panels; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles; particle accelerators; ozonisers; and plasma reactors.

According to one aspect of the present invention, there is provided a method of creating a field electron emission material, comprising the steps of:

a. printing upon a substrate an ink comprising:

i. a major component of fluid vehicle;

ii. a first minor component of electrically insulating material, either ready formed or provided within a precursor therefor; and

iii. a second minor component of electrically conductive particles: and

b. treating the printed ink to expel said major component and create said field electron emission material from said minor components on said substrate.

In the context of this specification, printing means a process that places an ink in a defined pattern. Examples of suitable processes are (amongst others): screen printing, Xerography, photolithography, electrostatic deposition, spraying, ink jet printing and offset lithography.

As will be understood by those skilled in the art, in the context of this specification, references to printing an ink upon a substrate include printing both directly on the substrate and also upon a layer or component that already exists upon the substrate.

Preferably, said substrate has an electrically conductive surface upon which said ink is printed.

Preferably, said particles comprise graphite.

Said particles maybe predominantly acicular.

Said particles may be predominantly lamelliform.

Said particles maybe predominantly equiaxed.

Preferably, said particles have a low amorphous content.

By particles of low amorphous content we mean materials where the amorphous content is less than 5% and, preferably, where the amorphous content cannot be detected by x-ray diffraction analysis. This means that the amorphous component is less than 1% or, in many cases, less than 0.1%. Byway of example, such particles maybe prepared from well crystallised feedstocks by jet-milling. This may apply especially to graphite particles.

Said particles may comprise nanotubes of carbon or other materials.

Preferably, said treatment of the printed ink is such that each of said particles has a layer of said electrically insulating material disposed in a first location between said conductive surface and said particle, and/or in a second location between said particle and the environment in which the field electron emission material is disposed, such that electron emission sites are formed at at least some of said first and/or second locations.

Said particles may be included within a mixture of a plurality of first particles together with a plurality of second particles of generally smaller dimensions than said first particles.

At least some of said second particles may decorate said first particles.

At least some of said second particles maybe disposed in interstices defined between said first particles.

Said second particles may comprise particles of at least two differing types.

Said second particles maybe more equiaxed than said first particles.

Said second particles maybe more acicular than said first particles.

Said first particles may comprise graphite and said second particles may comprise carbon blacks.

Said first particles may comprise graphite and said second particles may comprise fumed silica or Laponite.

Said first particles may comprise a resistive material and said second particles may comprise graphite.

Said first particles may comprise silicon carbide.

Said second particles may have a higher BET surface area value than said first particles.

Said second particles may be more crystalline than said first particles.

Said ink may contain said precursor for said electrically insulating material and said treatment of the printed ink may include subjecting the printed ink to conditions in which said precursor is converted into said electrically insulating material around at least part of each of said conductive particles.

Said conditions may include heating.

Said electrically insulating material may be provided as a substantially ready-formed layer on each of said electrically conductive particles.

Any method as above may include the preliminary step of mixing said minor components and adding them to said major component, thereby to form said ink.

In another aspect, the present invention provides a method of creating a solid, electrically insulating layer in a field emission device, comprising the steps of:

a. printing on a substrate an ink comprising:

i. a major component of fluid vehicle; and

ii. a minor component of electrically insulating material, either ready formed or provided within a precursor therefor: and

b. treating the printed ink to expel said major component and create said solid, electrically insulating layer from said minor component on said substrate.

Said solid, electrically insulating layer maybe formed as a gate insulator.

Any method as above may include said precursor for said electrically insulating material, said precursor being in the form of a sol-gel or polymer precursor.

Said precursor maybe a silica sol-gel.

Said precursor may be an alumina sol-gel.

Said precursor may be a polysiloxane.

Said precursor maybe a silsesquioxane polymer.

Preferably, said silsesquioxane is selected from the group comprising β-chloroethylsilsesquioxane; hydrogensilsequioxane; and acetoxysilsesquioxane.

Said electrically insulating material may be selected from the group comprising amorphous silica; ormosils; amorphous alumina and Laponite.

Said fluid vehicle may comprise water.

Said fluid vehicle may comprise an organic solvent.

Said fluid vehicle may contain at least one additive to control the rheology of the ink.

Preferably, said at least one additive includes at least one thickening agent.

Said thickening agent may comprise a fugitive soluble organic polymer.

In the context of this specification, the term “fugitive” means a material expected to be consumed (for example to “burn out”) completely during treatment (for example, curing or firing), and those skilled in the art will recognise that a small quantity of non-detrimental ash or residue may nevertheless remain in some instances.

Preferably, said fugitive soluble organic polymer is selected from the group comprising poly(vinyl alcohol; ethyl cellulose; hydroxyethyl cellulose; carboxymethyl cellulose; methylhydroxypropyl cellulose; hydroxypropyl cellulose; xanthan gum; and guar gum.

Said thickening agent may comprise a non-fugitive material.

Preferably, said non-fugitive material is selected from the group comprising fumed silica; carbon blacks; and Laponite.

A method as above may comprise at least one further additive to control further properties of the ink.

Preferably, said at least one further additive comprises at least one of an anti-foaming agent; a levelling agent; a wetting agent; a preservative; an air-release agent; a retarder; and a dispersing agent.

Any such further additive may perform more than one such function.

Said anti-foaming agent maybe a fugitive material.

Preferably, said fugitive material is selected from the group comprising butyl cellosolve; n-octanol; emulsions of organic polymers and organic metal-compounds; and silicone-free defoaming substances in alkylbenezene.

Said anti-foaming agent maybe a non-fugitive material.

Preferably, said non-fugitive material comprises a silicone.

Preferably, said dispersing agent is selected from the group comprising poly(vinyl) alcohol; modified polyurethane in butylacetate, methoxypropylacetate and sec. butanol; modified polyacrylate in meythoxypropanol; polyethylene glycol mono(4(1,1,3,3-tetramethylbutyl)phenyl)ether; and mineral oils.

Preferably, said said dispersing agent comprises a silicone oil.

Said at least one further additive may comprise at least one dispersing agent and at least one said minor component may have an affinity for that dispersing agent.

Preferably, said said levelling agent is selected from the group comprising poly(vinyl) alcohol; fluorocarbon modified polyacrylate in sec. butanol; organically modified polysiloxane in isobutanol; and solvent-free modified polysiloxane.

Preferably, said wetting agent is selected from the group comprising unsaturated polyamide and acid ester salt in xylene, n-butanol and monpropylenegylcol; and alkylol ammonium salt of a high molecular weight carboxylic acid in water.

Preferably, said preservative is selected from the group comprising phenols and formaldehydes.

Preferably, said air-release agent is selected from the group comprising silica particles and silicones.

Preferably, said retarder is selected from the group comprising 1,2-propanediol and terpineol.

Said printing may comprise screen printing.

Said printing may comprise ink-jet printing.

Said printing maybe selected from the group comprising offset lithography; pad printing; table coating and slot printing.

Preferably, said said substrate is porous and said step of treating the printed ink includes absorbing at least part of said fluid vehicle into said porous substrate.

Preferably, said said step of treating the printed ink causes the mean thickness of the insulator in the cured layer to be reduced to 10% or less of the thickness of the ink as printed.

The mean thickness of the insulator is the average height of the insulator above the substrate on which it is disposed, away from any other solid components of the ink such as said electrically conductive particles. In the vicinity of such particles, the thickness of the insulator can be influenced by the surface area and morphology of the particles. By “away from” said components such as said particles, we mean a distance of at least a particle's mean radius from its perimeter.

Preferably, said step of treating the printed ink causes the mean thickness of the insulator in the cured layer to be reduced to 5% or less of the thickness of the ink as printed.

Preferably, said step of treating the printed ink causes the mean thickness of the insulator in the cured layer to be reduced to 1% or less of the thickness of the ink as printed.

Preferably, said said step of treating the printed ink causes the mean thickness of the insulator in the cured layer to be reduced to 0.5% or less of the thickness of the ink as printed.

Preferably, said major component comprises at least 50% by weight of the ink.

Preferably, said major component comprises at least 80% by weight of the ink.

Preferably, said major component comprises at least 90% by weight of the ink.

Preferably, said major component comprises at least 95% by weight of the ink.

Preferably, the weight of the or each said minor component in total comprises less than 50% by weight of the ink.

Preferably, the weight of the or each said minor component in total comprises less than 10% by weight of the ink.

Preferably, the weight of the or each said minor component in total comprises less than 5% by weight of the ink.

Preferably, the weight of the or each said minor component in total comprises less than 2% by weight of the ink.

Preferably, the weight of the or each said minor component in total comprises less than 1% by weight of the ink.

The invention extends to a field electron emitter comprising field electron emission material that has been created by a method according to any of the preceding aspects of the invention.

The invention also extends to a field electron emission device comprising a field electron emitter as above and means for subjecting said emitter to an electric field in order to cause said emitter to emit electrons.

Such a field electron emission device may comprise a substrate with an array of patches of said field electron emitters, and control electrodes with aligned arrays of apertures, which electrodes are supported above the emitter patches by insulating layers.

Said apertures maybe in the form of slots.

A field electron emission device as above may comprise a plasma reactor, corona discharge device, silent discharge device, ozoniser, an electron source, electron gun, electron device, x-ray tube, vacuum gauge, gas filled device or ion thruster.

In a field electron emission device as above, the field electron emitter may supply the total current for operation of the device.

In a field electron emission device as above, the field electron emitter may supply a starting, triggering or priming current for the device.

A field electron emission device as above may comprise a display device.

Afield electron emission device as above may comprise a lamp.

Said lamp may be substantially flat.

Said emitter maybe connected to an electric driving means via a ballast resistor to limit current.

Said ballast resistor may be applied as a resistive pad under each said emitting patch.

Said emitter material and/or a phosphor may be coated upon one or more one-dimensional array of conductive tracks which are arranged to be addressed by electronic driving means so as to produce a scanning illuminated line.

Such a field electron emission device may include said electronic driving means.

Said field emitter maybe disposed in an environment which is gaseous, liquid, solid, or a vacuum.

A field electron emission device as above may comprise a cathode which is optically translucent and is so arranged in relation to an anode that electrons emitted from the cathode impinge upon the anode to cause electro-luminescence at the anode, which electro-luminescence is visible through the optically translucent cathode.

It will be appreciated that the electrical terms “conducting” and “insulating” can be relative, depending upon the basis of their measurement. Semiconductors have useful conducting properties and, indeed, maybe used in the present invention as conducting particles. In the context of this specification, each said conductive particle has an electrical conductivity at least 10² times (and preferably at least 10³ or 10⁴ times) that of the insulating material.

For a better understanding of the invention, and to show how embodiments of the same may be carried into effect, reference will now be made, byway of example, to the accompanying diagrammatic drawings, in which:

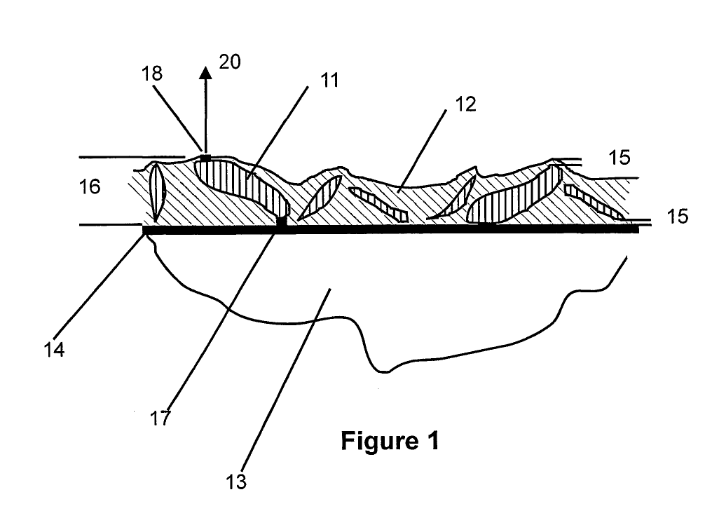

FIG. 1 shows a MIMIV field emitter material;

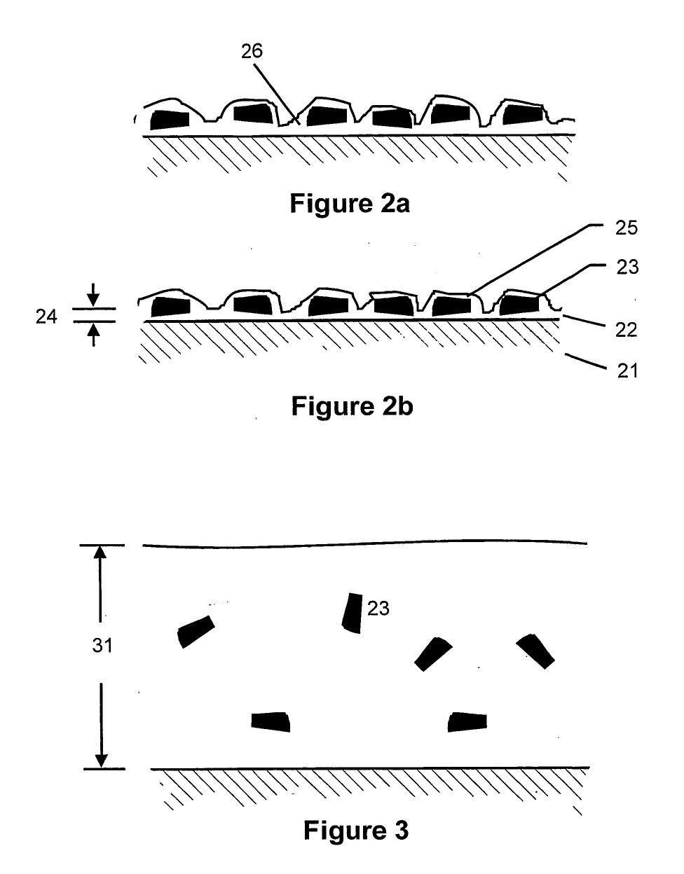

FIGS. 2a and 2b shows the dimensions of field emitting layers as deposited by spin coating and after subsequent firing;

FIG. 3 shows the dimensions of a field emitting layer as deposited by screen printing;

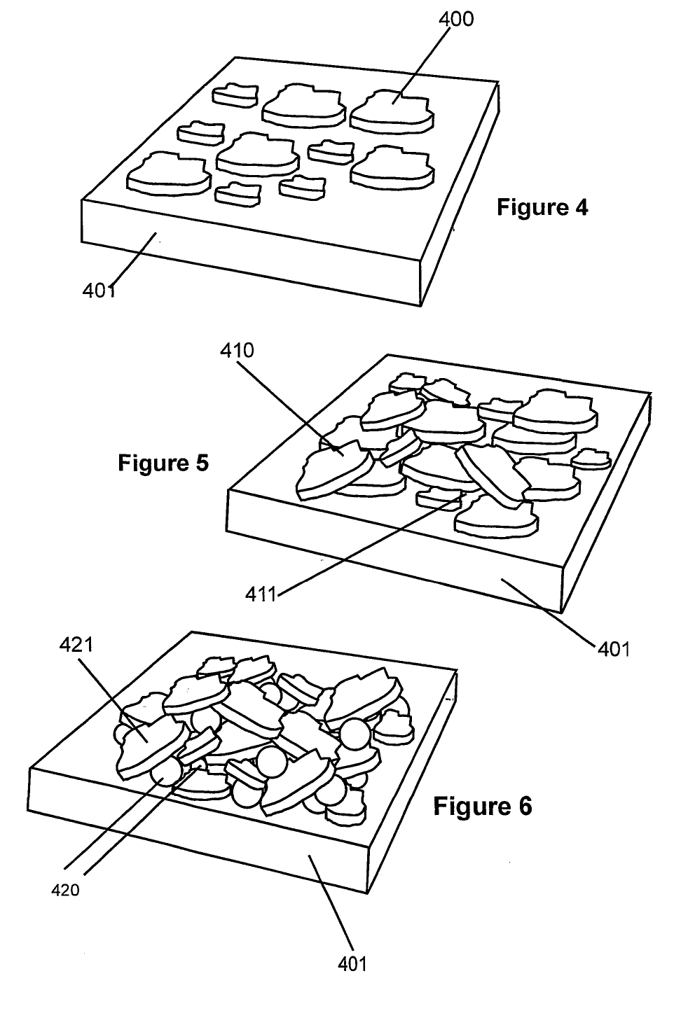

FIG. 4 shows the natural orientation of a low concentration of particles in a printed emitter layer;

FIG. 5 shows the orientation of a higher concentration of particles in a printed emitter layer;

FIG. 6 shows how a gap-filling phase maybe used to increase the density of a printed emitter layer;

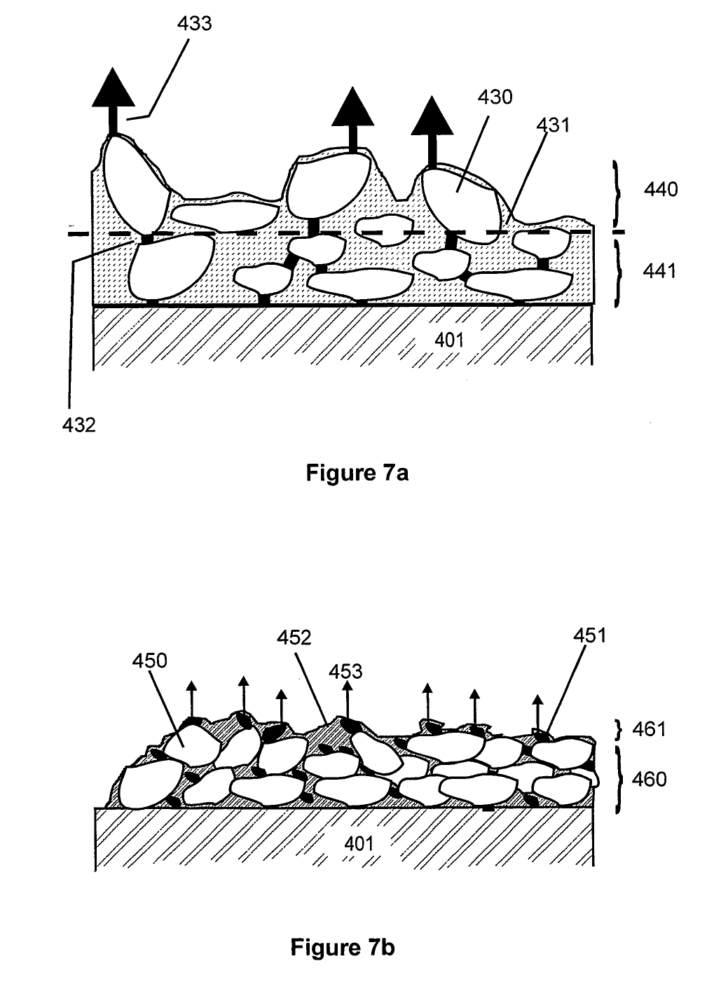

FIG. 7a shows how separate layers within a thick emitter function as emitter and resistive ballast;

FIG. 7b shows how insulating particles can be introduced into a thick emitter layer;

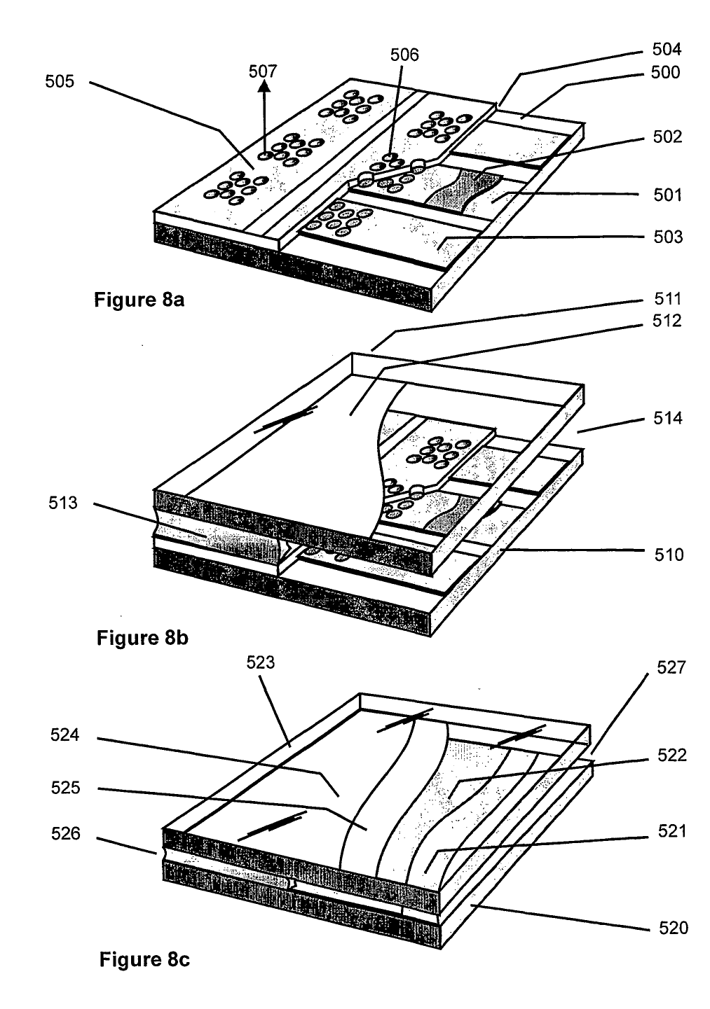

FIGS. 8a to 8c show respective examples of field-emitting devices using materials as disclosed herein;

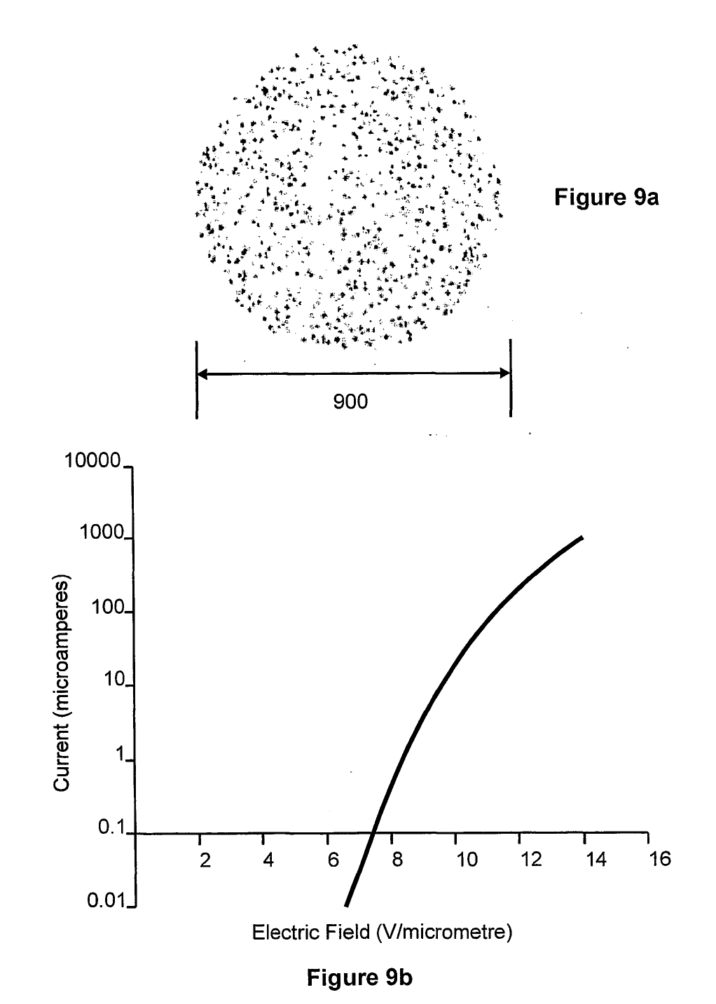

FIG. 9a shows an emission image of a cathode;

FIG. 9b shows a voltage-current characteristics for a cathode;

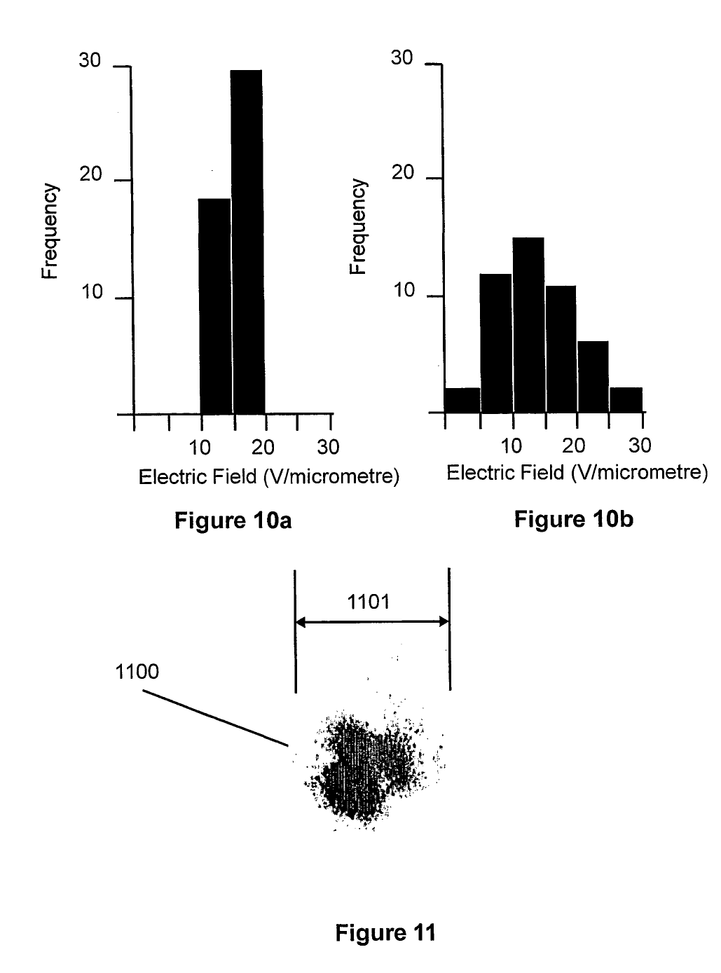

FIGS. 10a and 10b show two frequency histograms of threshold fields using two different sized probes;

FIG. 11 shows an emission image of another cathode;

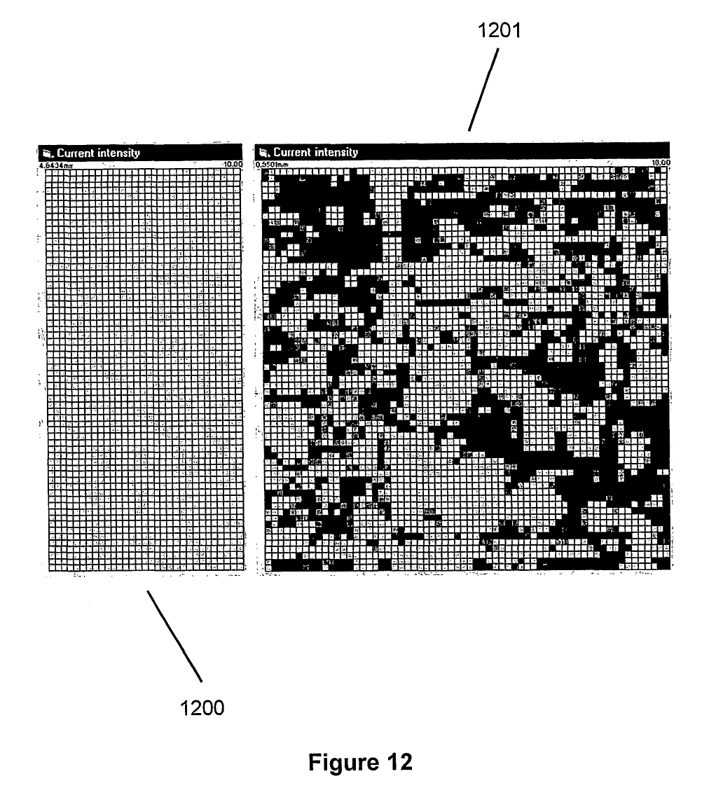

FIG. 12 shows emission characteristics measure using scanning probe anodes;

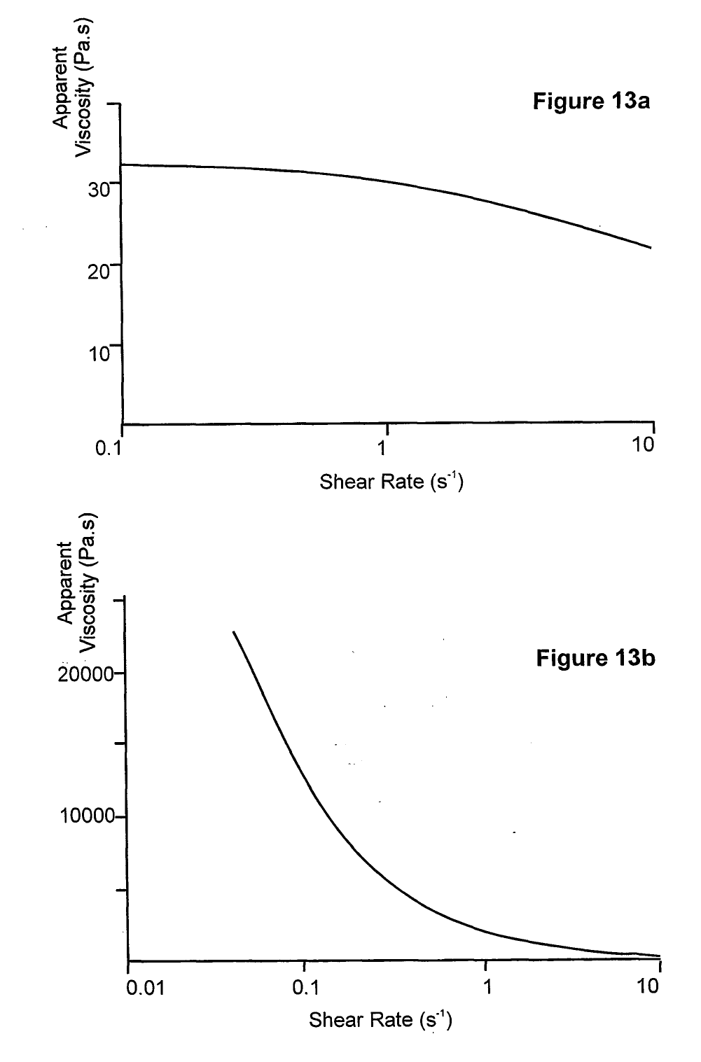

FIG. 13 shows rheometric data for a typical ink described herein;

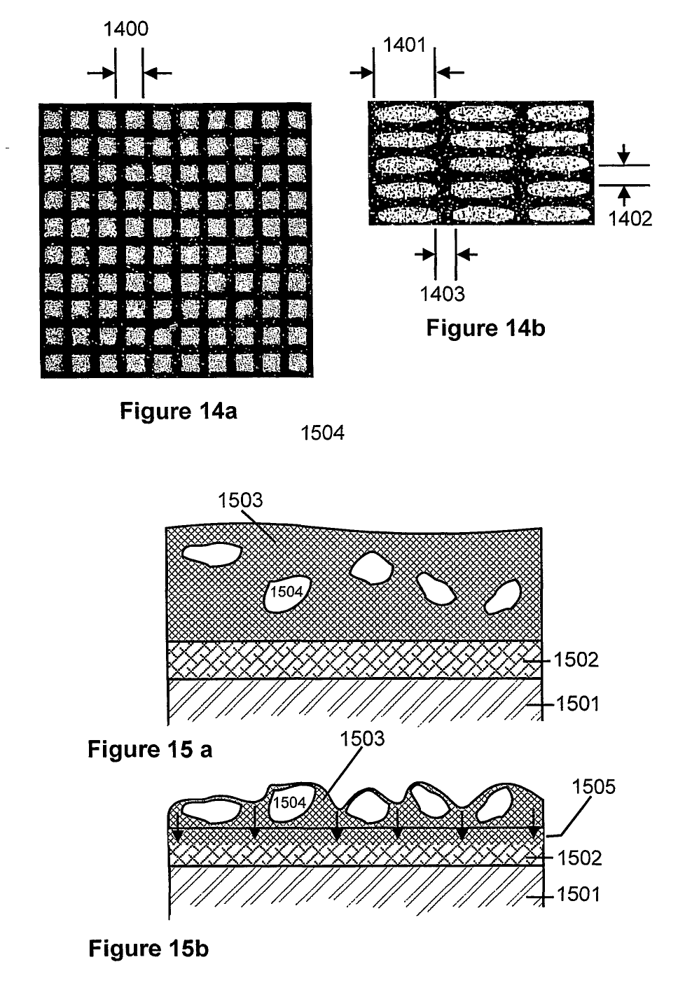

FIG. 14 shows examples of fine feature printing using inks described herein; and

FIGS. 15a and 15b illustrate how printing and emitting properties maybe adjusted by controlling the porosity of a substrate.

In the figures, like reference numerals denote like or corresponding parts.

The invention may have many different embodiments, and several examples are given in the following description. It is to be appreciated that, where practical, features of one embodiment or example can be used with features of other embodiments or examples.

FIG. 1 shows a MIMIV emitter material as described by Tuck, Taylor and Latham (GB 2 304 989) with electrically conducting particles 11 in an inorganic, electrically insulating matrix 12 on an electrically conducting substrate 13. For insulating substrates 13, a conducting layer 14 is applied before coating. The conducting layer 14 may be applied by a variety of means including, but not limited to, vacuum and plasma coating, electroplating, electroless plating and ink based methods.

The emission process is believed to occur as follows. Initially the insulator 12 forms a blocking contact between the particles 11 and the substrate 13. The voltage of a particle will rise to the potential of the highest equipotential it probes—this has been called the antenna effect. At a certain applied voltage, this will be high enough to create an electro-formed conducting channel 17 between the particle and the substrate. The potential of the particle then flips rapidly towards that of the substrate 13 or conducting layer 14, typically arranged as a cathode track. The residual charge above the particle then produces a high electric field which creates a second electro-formed channel 18 and an associated metal-insulator-vacuum (MIV) hot electron emission site. After this switch-on process, reversible field emitted currents 20 can be drawn from the site.

The standing electric field required to switch on the electro-formed channels is determined by the ratio of particle height 16 to the thickness of the matrix in the region of the conducting channels 15. For a minimum switch on field, the thickness of the matrix 12 at the conducting channels should be significantly less than the particle height. The conducting particles would typically be in, although not restricted to, the range 0.1 micrometres to 400 micrometres, preferably with a narrow size distribution.

By a “channel”, “conducting channel” or electro-formed channel” we mean a region of the insulator where its properties have been locally modified, usually by some forming process involving charge injection or heat. Such a modification facilitates the injection of electrons from the conducting back contact into the insulator such that the electrons may move through it, gaining energy, and be emitted over or through the surface potential barrier into the vacuum. In a crystalline solid the injection maybe directly into the conduction band or, in the case of amorphous materials, at an energy level where hopping conduction is possible.

Depositing a MIMIV or MIV emitter by printing, particularly screen printing, presents a challenge. In the past, the Applicants have deposited emitters by spin coating followed by firing. FIG. 2b shows the idealised structure of a heat-treated layer with conducting substrate 21, insulator layer 22 and conducting particles 25. We have found that the optimum mean insulator thickness 24 is approximately 100 nm: however, the insulator thickness over the tops of the particles 25 should be approximately 20 nm. FIG. 2a shows the as-spun layer before heat treatment, where the overall thickness of insulator precursor material 26 is of the same order of thickness as the heat-treated layers. Spin coating inks have a low viscosity and, as a result, suspensions of particles in them must be frequently agitated. Liquids of this viscosity, even with the aid of dispersing agents, cannot prevent particle clumping once a critical concentration is exceeded. This concentration is well below the ideal level for optimised emitters.

So far as printing field emitting structures based upon particulates is concerned, the distinct trend in the art has been to emulate normal thick film circuit practice and use an ink in the form of a paste. See, for example, Tcherepanov et al Pro. Tri-service/NASA Cathode Workshop, Cleveland, Ohio (1994), EP 0 905 737 A1; KR 99-18948; KR 99-12717; KR99-15280. By a “paste” we mean a malleable mixture wherein the particulate components comprise the majority of the formulation and wherein the rheological, and hence printing, properties are controlled to a large degree by friction between said particulate components.

An alternative that has been tried (KR 2000-20870) is to form a slurry of particles and insulator precursor that is viscous enough to enable a higher concentration of particles but still sufficiently liquid to be spin coated into a layer, albeit not a classic single layer MIMIV or MIV structure as described above. Such a slurry provides the worst of both worlds, for it is too viscous for inkjet printing and too liquid to screen print. The authors patterned their emitter films by means of a photolithographic lift-off process.

Preferred embodiments of the present invention provide methods of screen printing inks for classic MIMIV and MIV structures, which meet a challenge which is illustrated in FIG. 3. The ink's viscosity can now be much higher than previously proposed, and so particle clumping is much less of an issue, but the as-deposited layer thickness 31 is now approximately 20 micrometre. On heat-treatment we require this to shrink controllably to produce good quality films of the known optimum dimensions as shown in FIG. 2b. We shall call these “controllable high thickness reduction inks” (CHTR inks).

MIMIV and MIV emitter layer coatings contain two essential components:

1. Conductive particles; and

2. An insulator phase.

In the case of CHTR screen printing inks used to apply MIMIV and MIV emitter coatings, they may also contain other components (often temporary), added to control the rheological or other properties required during the application process. Fillers such as clays or fumed silica may be added to control the rheology of the ink.

Laponite, for example, is a synthetic clay with flakes of 25 nm mean diameter and has a profound effect on the viscosity of aqueous solutions by forming sol-gel solutions. Latexes may also be used to control viscosity. Many organic polymers, which can also be used, give a residue on thermal decomposition (often called “burn out” in the art). The residue may typically comprise carbon and/or salts and/or silica. Such additional materials may be removed after they have served their purpose during application and curing stages. Post-application treatment (usually heating) may also be necessary to convert precursor materials into final forms required for functional components of an insulator coating.

Emitter particles are most conveniently added to ink ready formed from the desired material and with the desired particle size distribution. However, treatments such as thermal decomposition, chemical reduction or other reactions may be used to transform a precursor material into the form required in the emitting material.

An insulator phase is preferably present as a thin, continuous layer over the whole emitter surface and, in its final form, it must be stable indefinitely under high vacuum. Although it is easy to form an insulating layer from organic polymers (e.g. S Bajic and R V Latham, (Journal of Physics D Applied Physics, vol 21 200-204 (1988)) and these have been shown to operate in a continuously pumped enclosure, they are unacceptable in a sealed, evacuated unit because of outgassing of volatile components. Moreover, the fabrication of an electron device often involves high temperature joining operations that would destroy an organic polymer. An inorganic coating having negligible vapour pressure is thus highly desirable, but is more difficult to form as a thin layer from a printable composition. Thin films of insulating metal oxide can be readily deposited in vacuo by evaporation or sputtering, but for easy and economical processing a liquid precursor is required which, together with desired conductive particles, can be incorporated into an ink which can be printed.

One type of liquid precursor is a liquid or soluble compound that will decompose to form a metal oxide on heating. There are many metal salts which will undergo such decomposition but which form particulate powdery deposits rather than the required film. A few, such as magnesium acetate, will form transparent coatings under certain conditions, such as spraying onto hot glass, but these tend to re-crystallise and to show poor adhesion. Organo-metallic complexes can give better results but high volatility leads to difficulty in confining the coating to the required area, and processing is often made difficult by, for example, their being extremely inflammable or even pyrophoric. One range of practicable materials is to be found in sol-gels, which can be produced from a wide range of elements. These materials will readily form films by coalescence and drying from the liquid state, and are generally compatible with a wide range of other materials.

Control of the chemical nature of the insulator is essential as this will determine its electrical properties, which in turn are crucial to the field emission process. Amorphous silica has been found to be one particularly suitable insulator and films can be formed via organic or inorganic chemical routes. Other insulators that may be used to good effect are amorphous alumina and Laponite.

In the case of the organic-based approach, materials such as silicones (polysiloxanes) maybe used. Equally, Arkles (U.S. Pat. No. 5,853,808) describes the use of silsequioxane polymers as precursors for the preparation of silica films. We have found these materials to be useful alternatives to sol-gel dispersions in the formulation of emitter inns. These materials are reversably soluble in a number of solvents, for example methoxypropanol. One polymer, β-chloroethylsilsesquioxane, has been found to be particularly useful. It is known that β-chloroethylsilsesquioxane and other silsesquioxanes such as hydrogensilsequioxane and acetoxysilsesquioxane yield ormosils (organically modified silicas) on heating or exposure to ultraviolet irradiation in the presence of ozone. Since, for example, some modified polysiloxanes are water soluble, the organic-based approach does not necessarily imply organic solvents.

In the case of the inorganic approach, sol-gel materials offer wide opportunities for easy variation of composition and are compatible with solvent mixtures such as: water; alcohol and water; and alcohol, acetone and water.

As previously pointed out, CHTR printing inks to deposit structures for field emission often have two unusual features that make their formulation particularly challenging.

1. The vehicle component of the ink is fugitive, being decomposed and/or volatilised by subsequent drying and heat treatment to leave the insulator or insulator precursor, and comprises a much greater proportion of the ink than is normal in other screen-printing arts—e.g. inks for decoration of ceramics or thick film hybrid circuits.

2. The proportion of solid particles in the ink is extremely low by conventional screen printing ink standards.

The first of these features restricts the choice of materials that can be incorporated to control the rheological properties of the ink. Any fugitive polymer introduced to increase the viscosity has to decompose and volatilise at temperatures that will not damage the rest of the structure e.g. deformation of the glass substrate. In practice this is likely to entail removal at a temperature that is not greater than 450° C. To ease this process it is also desirable to use the minimum amount of any additive. For inks based on organic solvents, exemplary materials are ethyl cellulose, usually dissolved in terpineol, and methacrylate polymers dissolved in a variety of mixtures of ester and hydrocarbon solvents.

The insulator may then be introduced via suitable precursor. In the case of silica it can be introduced by means of, for example, a suitable substituted siloxane (silicone), silsesquioxanes or silica sol-gel. Clean and complete thermal decomposition of these polymers is achieved by around 350° C. to yield silica or an ormosil.

Inks based on water not only avoid problems associated with the use of inflammable and harmful solvents, they allow the use of a wide range of water-based sol-gel materials for the formation of the insulator component of the emitter structure. The increase in viscosity required for printing can be achieved by the use of water soluble polymers such as poly(vinyl alcohol) or hydroxypropyl cellulose (HPC)—both are readily removed by thermal volatilisation. Poly(vinyl alcohol) or HPC have further advantages when used with sol-gel materials in that each can itself become incorporated (reacted) with the sol by condensation of the hydroxyl groups of the gel with those of the polymer side chains. This leads to a beneficial rise in viscosity of the ink allowing the use of reduced concentrations of polymer.

The control of rheology is also affected by the generally low particle loading required in these inks. Whereas in most printing inks, the particle concentration is large enough to make a major contribution to the viscosity of the ink, in some versions of these inks any effect of the particles on rheological properties is negligible and the rheological properties of the ink are, in the main, those of the vehicle and precursor or vehicle, precursor and filler. This is of particular importance with inks for screen-printing where a high particle loading helps to prevent the ink from bubbling as it is passed through the fine mesh of the printing screen. In the absence of this effect, these inks need an alternative mechanism to prevent bubbling during printing. One means is to incorporate an anti-foaming and/or air release agent into the ink. Polymer and ink additive manufacturers offer a variety of materials for this purpose such as the longer chain aliphatic alcohols or proprietary mineral oil type defoamants. Butyl cellosolve and n-octanol have been found to be effective with poly(vinyl alcohol), and n-Octanol is effective with hydroxypropyl cellulose. When used with sol-gels, the condensation of poly(vinyl alcohol) or hydroxypropyl cellulose side chains with the polymer induces a slight gelation of the solution which is highly advantageous as it increases the viscosity for a given amount of polymer. The gel also helps to eliminate any bubbling during screen printing.

Some polymers may also act as dispersants by both preventing the particles from flowing in the ink and by coating the particles leading to steric repulsion.

The ink may optionally contain: dispersing agents; a preservative; a retarder (to slow down the rate of drying of the ink); a wetting agent to improve wetting of the ink on the substrate.

The material for printing is usually, but not necessarily, a single liquid phase. However, the particulate component maybe dispersed using suitable surfactants in, for example, a mineral oil phase which is immiscible with the polymer and majority of solvents used.

Our prior patent publications (e.g. GB 2 304 989, GB 2 332 089) teach that the threshold field for electron emission is controlled by factors that include the enhancement of the macroscopic electric field by the particle—the so-called β factor. Moving now to FIG. 4, graphite, one of our preferred particles, generally has a flake-like habit and, as a result the particles 400 tend to be pulled down onto the surface of the substrate 401 by the liquid phase of the ink (not shown). It will be clear to those skilled in the art that in this state its β factor is at its lowest value. FIG. 5 shows the structure of a film as the printed thickness is increased: as before, the insulator phase is not shown. In this case the flake-like particles now form a more chaotic structure with many 410 tilted upwards increasing their associated β factors. The β factor maybe by increased further by using selected grades of graphite which as a result of the specific milling conditions used, have a high proportion of acicular particles. Both arrangements have two potential shortcomings. Firstly there are many voids 411 and, if the insulator concentration in the ink is increased to fill them, the resulting insulator layer over the particles may be too thick for low field emission. Secondly, with the correct amount of insulator for emission, the film maybe both mechanically weak and porous, making it difficult to build gate and other structures on top of it. FIG. 6 shows a method by which this problem maybe overcome. More equiaxed particles such as carbon blacks 420, of sizes chosen to fill the voids, are added to the flake-like particles 421. Carbon blacks are in many ways ideal since the small primary particles aggregate to form structures not unlike bunches of grapes and these aggregates then go on to form larger agglomerates. Not only do the equiaxed particles increase the strength and density of the film, they also have a tendency to prop up the flakes and, consequently, increase their associated β factors. Another approach is to use graphite which has been milled to increase the proportion of equiaxed particles which will protrude above the surface irrespective of their orientation relative to it and also help to prop up any less equiaxed particles.

Our prior patent GB 2 304 989 describes the use of resistive ballast layers between the emitting particles and the conducting substrate. FIG. 7a shows such an arrangement formed from a thick film as in FIG. 5, with substrate 401, conductive particles 430 and insulator 431. Following the usual electro-forming stage, conducting channels 432 and 433 are established between the conductive particles 430. The channels 433 at the surface become the sources of electron emission and the channels 432 within the body of the layer help to stabilise the emitted current. Thus region 440 of the film is the emitter layer as taught in our previous work and region 441 provides a ballast layer.

FIG. 7b shows how the above concept maybe extended to increase the resistive ballasting effect. In this case resistive particles such as silicon carbide 450 are mixed with smaller conductive particles 451 (e.g. graphite) known to give the best emission in conjunction with the insulator layer 452. Relative sizes and concentrations are chosen such that the smaller conducting particles do not collectively form conducting pathways through the resistive layer. The smaller conductive particles form MIMIV emitter sites 453 on the surface of the larger resistive particles. Field enhancement at the emitting sites is enhanced above their values on a flat substrate by the β factors of the larger resistive particles augmenting those of the smaller conductive particles that decorate their surfaces. Electrical connection between the resistive particles 450 is by percolation through the matrix afforded by the insulating material 452. Thus, region 461 of the film is the emitter layer as taught in our previous work and region 460 provides a ballast layer. Of course the larger particles need not be resistive if only an increase in β factor is required. In such an arrangement, an ink with two sizes of, for example, graphite particles may be formulated to reduce the operating field of the finished emitter. The properties of the smaller particles may also be carefully chosen for good emission e.g. good crystallinity and/or acicular shape.

Preferred embodiments of the present invention employ graphite particles at least partly coated or decorated with amorphous silica which is doped and/or heavily defective. By “heavily defective” is meant silica in which the band edges are diffuse with a plurality of states that may, or may not, be localised such that they extend into the band-gap to facilitate the transport of carriers by hopping mechanisms. By “doped” we mean doping as it is described in our patent GB 2 353 631. However, perfectly functional emitters maybe made using other insulator systems e.g: alumina and Laponite.

Examples of CHTR ink formulations using the teachings of this document are described below.

To avoid repetition a number of key materials are defined below—all values given are typical and not absolute.

Graphite A is a high purity synthetic lamelliform material with a d90 value of 6.5 micrometres measured using a Malvern instrument. Its specific surface area measured using the BET method is 20 square metres per gram. The Brunauer, Emmett, and Teller (BET) method is described by the authors in Journal of American Chem. Society. 60, 309, 1938. Its dibutylphthalate absorbtion is 164 grams per 100 grams.

Graphite B is a natural lamelliform material of with a d₉₀ value of 6.6 micrometres measured using a Malvern instrument.

Graphite C is a high-purity synthetic lamelliform material with a d₉₀ value of 4.7 micrometres measured using a Malvern instrument. Its specific surface area measured using the BET method is 26 square metres per gram.

Graphite D1 is similar to Graphite A but the feedstock and milling conditions chosen to enhance the proportion of equiaxed particles. It has a d₉₀ of 6.1 micrometres measured using a Malvern instrument.

Graphite D2 is similar to Graphite A but the feedstock and milling conditions chosen to enhance the proportion of acicular particles. It has a d₉₀ of 6.5 micrometres measured using a Malvern instrument. Its specific surface area measured using the BET method is 17 square metres per gram.

Carbon Nanotubes D3 are single and/or multi-walled carbon nanotubes grown using the conventional arc-discharge method in a helium atmosphere which are subsequently ground, acid washed, and rinsed in de-ionised water.

Graphite E is a ball milled synthetic graphite of mixed equiaxed and lamelliform particles with a size range up to 8 micrometres. Its specific surface area measured using the BET method is 127 square metres per gram.

Graphite F is a natural material (Ceylon) with particle sizes in the range 1 to 13 micrometres with a typical value of 6 micrometres measured using a Malvern instrument. Its specific surface area measured using the BET method is in the range 9 to 21 square metres per gram.

Graphite G is a natural lamelliform material from with particle sizes in the range 4 to 7 micrometres with a typical value of 6 micrometres measured using a Malvern instrument. Its specific surface area measured using the BET method is 11.6 square metres per gram.

Silicon carbide H has particles with a d₉₀ of 1.48 micron determined using a Malvern instrument. The free Silicon content is less than 0.1% with 95% being beta-SiC. Its specific surface area measured using the BET method is 11.78 square metres per gram.

Graphite dispersion I is an aqueous paste-like dispersion of Graphite A. It has a pH value of 5.5±1.

Graphite dispersion J is an aqueous bead-milled pre-dispersed colloidal graphite with 11% solids content. Of the particulate phase 90% are submicron with less than 5% over 5 micrometres. Its pH value is greater than 10.

Graphite dispersion K is a stable colloidal graphite suspension in mineral oil with a solids content of 20%. Of the particulate phase 95% are finer than 1 micrometres.

Hydroxypropyl cellulose L has an average molecular weight of 140 000 determined by size exclusion chromatography.

Hydroxypropyl cellulose M has an average molecular weight of 370 000 determined by size exclusion chromatography.

Poly(vinyl alcohol) N is 88% partially hydrolysed polyvinyl alcohol in 4% by volume aqueous solution at 20 degrees C. The viscosity is 40 mPa.s

Silicon dioxide precursor P is a solution of β-chloroethylsilsesquioxane in methoxypropanol.

### EXAMPLE 1

| | Quantity by |
|---|---|
| Materials | weight |
| Graphite A | 1.50 |
| 15 wt % solution of poly(vinyl | 66.65 |
| alcohol) N in de-ionised water | |
| De-ionised water | 10.85 |
| Silica sol-gel in iso-propanol | 20.00 |
| n-butanol | 1.00 |

The graphite powder is first mixed with the poly(vinyl alcohol) solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. The final additions of water and solvent require no more than thorough stirring.

The ink is then placed in a well-sealed container and kept at 60° C. for 2 hours, then allowed to cool and to stand for 24 hours. This last step is essential to allow the stabilisation of reaction between the sol-gel and the poly(vinyl alcohol) which induces a slight gelation of the ink. This gelation modifies the rheological properties of the ink and enables it to be screen-printed.

The silica sol-gel was prepared from the following materials:

| | Quantity by |
|---|---|
| Materials | weight |
| Tetraethyl orthosilicate | 20.83 |
| Iso-propanol | 48.50 |
| 4 vol % Nitric Acid | 5.57 |

Measure the reactants into suitable containers, cover and cool to approximately 5° C.

In a cooled vessel mix the tetraethyl orthosilicate and iso-propanol and stir to maintain a steady but vigorous agitation of the mixture. Add the nitric acid, which catalyses the reaction and seal. Stir for 2 hours, maintaining the temperature below 10° C. Transfer the mixture to a storage vessel and store in a refrigerator.

### EXAMPLE 2

| | Quantity by |
|---|---|
| Materials | weight |
| Graphite A | 7.50 |
| 10 wt % solution of hydroxypropyl | 71.5 |
| cellulose L in water | |
| Aqueous silica sol-gel | 20.00 |
| 1-octanol | 1.00 |

The graphite powder is first mixed with the hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. Finally the 1-octanol is added and mixed. The ink is then placed in a well-sealed container and kept at 22° C. and left to stand for 24 hours.

The aqueous silica sol-gel was prepared as follows:

| | Quantity by |
|---|---|
| Materials | weight |
| Tetraethyl orthosilicate | 27.8 |
| De-ionized water | 72.0 |
| Concentrated nitric acid | 0.2 |

The tetraethyl orthosilicate was added to the water at room temperature and stirred vigorously and then the nitric acid was added. The stirred mixture was then held at ^{˜}48° C. for one hour, at the end of which the mixture had become a clear colourless liquid. This liquid was then transferred to a bottle and refrigerated.

### EXAMPLE 3

In an alternative preparation, the graphite can be incorporated in the form of dispersions rather than dry particles and the range of particle sizes increased by the use of mixed dispersions:

| | Quantity by |
|---|---|
| Materials | weight |
| Predispersed colloidal | 6.8 |
| graphite J(filtered through 8 | |
| micrometer filter) | |
| Predispersed graphite dispersion I | 6.8 |
| (filtered through 8 micrometer filter) | |
| Acetic acid | 1 |
| Hydroxypropyl cellulose solution | 41 |
| Silica sol-gel in 1,2-propanediol | 4.5 |
| De-ionised water | 9.69 |
| Butoxyethanol | 17.1 |

The carefully stirred and filtered graphite dispersions are mixed together and then acetic acid is added to adjust pH to approximately 3. The hydroxypropyl cellulose solution and the silica sol-gel were then added. The flow properties and viscosity are adjusted with the additional butoxyethanol and water and the composition roller milled to obtain a well dispersed, smooth material for screen printing. The ink is then placed in a well-sealed container and kept at 22° C. and left to stand for 24 hours.

The silica sol-gel was prepared from the following materials:

| | Quantity by |
|---|---|
| Materials | weight |
| Tetraethyl orthosilicate | 28.05 |
| 1,2-propanediol | 20.72 |
| 4 wt % Nitric Acid | 6.00 |

Measure the reactants into suitable containers, cover and cool to approximately 5° C.

In a cooled vessel mix the tetraethyl orthosilicate and 1,2-propanediol and stir to maintain a steady but vigorous agitation of the mixture. Add the nitric acid, which catalyses the reaction and seal. Stir for 2 hours, maintaining the temperature below 10° C. Transfer the mixture to a storage vessel and store in a refrigerator.

The hydroxypropyl cellulose solution was prepared as follows:

| | |
|---|---|
| Materials | Quantity |

| | | |
|---|---|---|
| Hydroxypropyl cellulose L | 30 | g |
| Ethanol | 54 | ml |
| 1,2-propanediol | 180 | ml |
| De-ionised water | 126 | ml |

The solvents are placed in a stirred reaction flask fitted with a heater and condenser. The solvent mixture is stirred vigorously at room temperature and the polymer added slowly to ensure that the powder is dispersed into the liquid. The flask is then heated with continuous stirring to 80° C., stirred at this temperature for 15 minutes and then cooled to room temperature. The solution should be clear and of uniform viscosity.

### EXAMPLE 4

| | Quantity by |
|---|---|
| Materials | weight |
| Predispersed colloidal graphite J | 20 |
| (filtered through 8 micrometer | |
| filter) | |
| Predispersed graphite dispersion I | 7.6 |
| (filtered through 8 micrometer | |
| filter) | |
| Acetic acid | 1.0 |
| Hydroxypropyl cellulose solution | 31 |
| Silica sol-gel in iso-propanol | 7.37 |
| Butoxyethanol | 3.0 |

The filtered graphite dispersions are mixed together and then acetic acid is added to adjust pH to approximately 3. The hydroxypropyl cellulose solution and the silica sol-gel were then added. The flow properties and viscosity are adjusted with the additional butoxyethanol and water and the composition roller milled to obtain a well dispersed, smooth material for screen printing. The ink is then placed in a well-sealed container and kept at 22° C. and left to stand for 24 hours.

The silica sol-gel was prepared in the same manner as described in Example 1. The hydroxypropyl cellulose solution was prepared in the same manner as described in Example 3.

### EXAMPLE 5

| | Quantity by |
|---|---|
| Materials | weight |
| Graphite A | 1.3 |
| Silica sol-gel in 1,2-propanediol | 4.55 |
| 1,2-propandiol | 24.37 |
| Hydroxypropyl cellulose solution | 32 |
| Iso-propanol | 11.73 |
| De-ionised water | 9.5 |
| Butoxyethanol | 17.36 |

The graphite and silica sol gel are mixed and the propane-1,2-diol added. The ink is mixed to a smooth paste using ultrasonic agitation. The polymer and remaining solvents are then added before triple roll milling the ink several times to ensure uniformity. The ink is then placed in a well-sealed container and kept at 22° C. and left to stand for 24 hours.

The silica sol-gel was prepared in the same manner as described in Example 3. The hydroxypropyl cellulose solution was prepared in the same manner as described in Example 3.

### EXAMPLE 6

| | Quantity by |
|---|---|
| Materials | weight |
| Graphite A | 2.39 |
| 5 wt % Laponite solution in de- | 7.5 |
| ionised water | |
| 1,2-Propanediol | 15 |
| Hydroxypropyl cellulose solution | 19 |
| Butoxyethanol | 12 |

The graphite and Laponite solutions are mixed with the 1,2-propanediol with the aid of ultrasonic agitation. The hydroxypropyl cellulose solution and butoxy ethanol are stirred in and the material passed several time through a triple roll mill to obtain uniform consistency. The ink is then placed in a well-sealed container and kept at 22° C. and left to stand for 24 hours.

The hydroxypropyl cellulose solution was prepared in the same manner as described in example 3. However, in this case, 22.5 g of hydroxypropyl cellulose was used.

Laponite is a commercial, synthetic, clay mineral supplied by.

Laporte Industries Ltd.

Moorfield Road

Widnes

Cheshire WA8 0JU

United Kingdom

### EXAMPLE 7

| | Quantity by |
|---|---|
| Materials | weight |
| Graphite G | 3.00 |
| 15 wt % solution of poly(vinyl | 10.00 |
| alcohol) N in de-ionised water | |
| Silica sol-gel in iso-propanol | 5.00 |
| 1,2-propanediol | 2.00 |
| 1-Octanol | 0.20 |

The graphite powder is first mixed with the poly(vinyl alcohol) solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. The final additions of water and solvent require no more than thorough stirring. The ink is then placed in a well-sealed container and kept at 22° C. and left to stand for 24 hours.

The poly(vinyl alcohol) solution and the silica sol-gel were both prepared in the same manner as described in Example 1.

### EXAMPLE 8

| | Quantity by |
|---|---|
| Materials | weight |
| Graphite F | 3.00 |
| 15 wt % solution of poly(vinyl | 10.00 |
| alcohol) N in de-ionised water | |
| Silica sol-gel in iso-propanol | 5.00 |
| 1,2-propanediol | 2.00 |
| 1-Octanol | 0.20 |

The graphite powder is first mixed with the poly(viny alcohol) solution by means appropriate to the lot size. The sol-gel is then added to the mixture and carefully incorporated. The large difference in viscosity between the polymer solution and the sol-gel may mixing difficult. The sol-gel should be added a little at a time, the failing viscosity of the mixture making subsequent additions easier. The final additions of water and solvent require no more than thorough stirring. The ink is then placed in a well-sealed container and kept at 22° C. and left to stand for 24 hours.

The poly(viny alcohol) solution and the silica sol-gel solution were both prepared in the same manner as described in Example 1.

### EXAMPLE 9

| | Quantity by |
|---|---|
| Materials | weight |
| Graphite E | 0.9 |
| Hydroxypropyl cellulose solution | 19.23 |
| Silica sol-gel in iso-propanol | 7.50 |
| De-ionised water | 4.93 |
| 1,2-propanediol | 13.13 |
| Iso-propanol | 4.32 |

The graphite powder is first mixed with the Hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. The final additions of water and solvent require no more than thorough stirring. The ink is then placed in a well-sealed container and kept at 22° C. and left to stand for 24 hours.

The hydroxypropyl cellulose solution was prepared in the same manner as described in Example 3. The silica sol-gel solution was prepared in the same manner as described in Example 1.

### EXAMPLE 10

| | Quantity by |
|---|---|
| Materials | weight |
| Graphite B | 0.75 |
| Hydroxypropyl cellulose solution | 17.95 |
| Silica sol-gel in iso-propanol | 5.00 |
| De-ionised water | 5.50 |
| 1,2-propanediol | 14.04 |
| Iso-propanol | 6.76 |
| Butyl cellosolve | 10.00 |

The graphite powder is first mixed with the Hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the failing viscosity of the mixture making subsequent additions easier. The final additions of water and solvent require no more than thorough stirring. The ink is then placed in a well-sealed container and kept at 22° C. and left to stand for 24 hours.

The hydroxypropyl cellulose solution was prepared in the same manner as described in Example 3. The silica sol-gel solution was prepared in the same manner as described in Example 1.

### EXAMPLE 11

| | Quantity by |
|---|---|
| Materials | weight |
| Graphite D1 or Graphite D2 | 0.75 |
| Hydroxypropyl cellulose solution | 17.95 |
| Silica sol-gel in iso-propanol | 5.00 |
| De-ionised water | 5.50 |
| 1,2-propanediol | 14.04 |
| Iso-propanol | 6.76 |
| Butyl cellosolve | 10.00 |

The graphite powder is first mixed with the Hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. The final additions of water and solvent require no more than thorough stirring. The ink is then placed in a well-sealed container and kept at 22° C. and left to stand for 24 hours.

The hydroxypropyl cellulose solution was prepared in the same manner as described in Example 3. The silica sol-gel solution was prepared in the same manner as described in Example 1.

### EXAMPLE 12

An example of one suitable formulation is as follows

| | Quantity by |
|---|---|
| Materials | weight |
| Graphite A | 1.50 |
| 4 wt % solution of hydroxypropyl | 88.50 |
| cellulose M in 1-methoxy-2- | |
| propanol | |
| Silicon dioxide precursor P | 10.00 |

The powder is first mixed with the hydroxypropyl cellulose solution by means appropriate to the lot size. The silicon dioxide precursor P is then added to the mixture and carefully incorporated. The large difference in viscosity between the polymer solution and the precursor P may make mixing difficult. The precursor should be added a little at a time, the failing viscosity of the mixture making subsequent additions easier. The final additions of precursor require no more than thorough stirring. The ink is then placed in a well-sealed container then allowed to stand for 24 hours.

### EXAMPLE 13

| | Quantity by |
|---|---|
| Materials | weight |
| Graphite C | 1.00 |
| Hydroxypropylcellulose solution | 43.67 |
| in 1,2-propanediol | |
| Silica sol-gel in 1,2-propanediol | 5.33 |

The graphite powder is first mixed with the Hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the falling viscosity of the mixture making subsequent additions easier. The final additions of water and solvent require no more than thorough stirring. The ink is then placed in a well-sealed container and kept at 22° C. and left to stand for 24 hours.

The hydroxypropyl cellulose solution was prepared in the same manner as described in Example 3 while heating from temperature. However, in this case, it contains:

| | Quantity by |
|---|---|
| Materials | weight |
| Hydroxypropyl cellulose L | 36.0 |
| 1,2-propanediol | 364.0 |

The silica sol-gel was prepared from the following materials:

| | Quantity by |
|---|---|
| Materials | volume |
| Tetraethyl orthosilicate | 74 |
| 1,2-propanediol | 108 |
| De-ionised water acidified to pH 1 | 18 |
| using nitric acid | |

In a vessel mix the tetraethyl orthosilicate and 1,2-propanediol and stir to maintain a steady but vigorous agitation of the mixture. Add the acidifed water, which catalyses the reaction and seal. Stir for 2.5 hours, maintaining the temperature at 20° C. Transfer the mixture to a storage vessel and store in a refrigerator.

### EXAMPLE 14

The material for printing is usually, but not necessarily, a single liquid phase. In the following example the graphite is supplied in a mineral oil phase which is immiscible with the polymer solution and majority of solvents used. However the graphite rich phase can be stabilised by suitable surfactants:

| | Quantity by |
|---|---|
| Material | weight |
| Graphite dispersion in mineral oil K | 2.5 |
| polyethylene glycol mono(4- | 1 |
| (1,1,3,3- | |
| tetramethylbutyl)phenyl)ether | |
| Hydroxypropyl cellulose solution | 42.8 |
| Silica sol-gel in iso-propanol | 3 |
| 1,2-propandiol | 5 |
| Xylene | 1.5 |
| Methoxypropanol | 1.5 |
| Octanol | 1 |

The graphite in mineral oil is mixed with polyethylene glycol mono(4-(1,1,3,3-tetramethylbutyl)phenyl)ether surfactant and the remaining components. The graphite is in the minor, mineral oil phase, and after printing is distributed in sharply localised areas.

The hydroxypropyl cellulose solution was prepared in the same manner as described in example 3. However, in this case, 22.5 g of hydroxypropyl cellulose was used. The silica sol-gel was prepared in the same manner as described in Example 1.

### EXAMPLE 15

| | Quantity by |
|---|---|
| Material | weight |
| Graphite A | 1.5 |
| Silicone oil of 10 cps viscosity | 0.1 |
| Hydroxypropyl cellulose solution | 29 |
| Butoxyethanol | 15 |
| 1,2-propanediol | 10 |
| Silica sol-gel in iso-propanol | 2 |

The graphite, silicone oil and polymer are mixed to a smooth paste. The solvents are then added and finally the silica sol-gel is mixed in before triple roll milling. The ink is then placed in a well-sealed container and kept at 22° C. and left to stand for 24 hours. The hydroxypropyl cellulose solution was prepared in the same manner as described in Example 3. The silica sol-gel was prepared in the same manner as described in Example 1.

### EXAMPLE 16

| | Quantity by |
|---|---|
| Materials | weight |
| Graphite A | 7.50 |
| 10 wt % solution of hydroxypropyl | 71.5 |
| cellulose L in water | |
| Aqueous alumina sol-gel | 20.00 |
| 1-octanol | 1.00 |

The graphite powder is first mixed with the hydroxypropyl cellulose solution by means appropriate to the lot size. The sol-gel is then added to the mixture and carefully incorporated. The large difference in viscosity between the polymer solution and the sol-gel may make mixing difficult. The sol-gel should be added a little at a time, the failing viscosity of the mixture making subsequent additions easier. Finally the 1-octanol is added and mixed. The ink is then placed in a well-sealed container and kept at 22° C. and left to stand for 24 hours.

The aqueous alumina sol-gel was prepared as follows:

| | |
|---|---|
| Materials | Quantity |

| | | |
|---|---|---|
| Aluminium tri-sec-butoxide | 17.2 | g |
| De-ionized water | 126 | ml |
| Concentrated nitric acid | 0.31 | ml |

The aluminium tri-sec-butoxide was hydrolysed in the water at 75° C. with vigorous stirring for 20 minutes. The solution was then heated to 85° C. and the nitric acid added. The mixture was then stirred continuously at this elevated temperature for about 20 hours, at the end of which the mixture had become a clear colourless liquid. This liquid was then transferred to a bottle and refrigerated.

### EXAMPLE 17

| | Quantity by |
|---|---|
| Materials | weight |
| Predispersed colloidal graphite J | 14.7 |
| (filtered through 8 micrometer | |
| filter) | |
| Silicon carbide H | 0.45 |
| Hydroxypropyl cellulose solution | 30 |
| Silica sol-gel in iso-propanol | 5.5 |
| 1,2-propanediol | 4.8 |
| Butoxyethanol | 6.4 |

The filtered graphite dispersion, silicon carbide and silica sol gel are mixed, acidified and gently heated at 65-70° C. until coagulation occurs. The hydroxypropyl cellulose and solvents are then added and the mixture triple roll milled until of uniform consistency. The ink is then placed in a well-sealed container and kept at 22° C. and left to stand for 24 hours.

The silica sol-gel was prepared in the same manner as described in Example 1. The hydroxypropyl cellulose solution was prepared in the same manner as described in Example 3.

### EXAMPLE 18

| | Quantity by |
|---|---|
| Materials | weight |
| Graphite A | 2.27 |
| 2 wt % Laponite solution in de- | 18.75 |
| ionised water | |
| Acetic acid | 1 |
| 14 wt % silica solgel in propan2ol | 1.25 |
| Hydroxypropyl cellulose solution | 24 |

The graphite particles and Laponite solution are mixed, acidified and heated to 100° C. for 5 minutes. The silica sol-gel and hydroxypropyl cellulose are then added and the mixture passed through a triple roll mill. The ink is then placed in a well-sealed container and kept at 22° C. and left to stand for 24 hours.

The hydroxypropyl cellulose solution and the silica sol-gel were both prepared in the same manner as described in example 3. However, in this case, 22.5 g of hydroxypropyl cellulose was used for the polymer solution. Laponite may be obtained from the same Laporte Industries address given in Example 6.

### EXAMPLE 19

| | Quantity by |
|---|---|
| Materials | weight |
| Carbon Nanotubes D3 | 1.1 |
| Silica sol-gel in 1,2-propanediol | 4.55 |
| 1,2-propandiol | 24.37 |
| Hydroxypropyl cellulose solution | 32 |
| Iso-propanol | 11.73 |
| De-ionised water | 9.5 |
| Butoxyethanol | 17.36 |

The carbon nanotubes and silica sol gel are mixed and the propane-1,2-diol added. The ink is mixed to a smooth paste using ultrasonic agitation. The polymer and remaining solvents are then added before triple roll milling the ink several times to ensure uniformity. The ink is then placed in a well-sealed container and kept at 22° C. and left to stand for 24 hours.

The silica sol-gel was prepared in the same manner as described in Example 3. The hydroxypropyl cellulose solution was prepared in the same manner as described in Example 3.

Nanotubes of materials other than carbon may be used in alternative formulations.

Inks may also be prepared using combinations of the following functional materials.

Thickening agents: Ethyl cellulose, hydroxyethyl cellulose, carboxymethyl cellulose, methylhydroxypropyl cellulose, hydroxypropyl cellulose, xanthan gum, guar gum.

Anti-foaming agents: Emulsions of organic polymers and organic metal-compounds for aqueous based inks (e.g. EFKA-2526, EFKA-2527); silicone free defoaming substances in alkylbenezene (e.g. EFKA-2720).

Levelling agents: Fluorocarbon modified polyacrylate in sec. butanol for both aqueous and non-aqueous inks (e.g. EFKA-3772); organically modified polysiloxane in isobutanol (e.g. EFKA-3030); solvent-free modified polysiloxane (e.g. EFKA-3580).

Wetting agents: Unsaturated polyamide and acid ester salt in xylene, n-butanol and monopropyleneglycol (e.g. EFKA-5044); anionic wetting agents of alkylol ammonium salts of a high molecular weight carboxylic acid in water (e.g. EFKA-5071).

Preservatives: phenol, formaldehyde.

Air-release agents: silica particles, silicones.

Retarder: 1,2-propanediol, terpineol.

Dispersing agents: Modified polyurethane in butylacetate, methoxypropylacetate and sec. butanol (e.g. EFKA-4009); modified polyacrylate in methoxypropanol (EFKA-4530), polyethylene glycol mono(4-(1,1,3,3-tetramethylbutyl)phenyl)ether.

Methylhydroxypropyl cellulose and other thickeners at lower concentrations may also serve this function. In fact many additives may have multiple functionality.

EFKA products may be obtained from:

EFKA Additives bv

Innovatielaan 11

8466 SN Nijehaske

The Netherlands

Since the printing properties are not controlled by low concentration of particles they can be removed entirely to leave a CHTR ink for the printing of, for example, the gate insulator of a field emission device.

The above CHTR inks all have theological properties suitable for screen printing. Their typical rheological properties are illustrated by the exemplary flow curve shown in FIG. 13b. The theological measurements were made using a Bohlin CV 120 rheometer using cone and plate geometry. FIG. 13b shows the clearly different rheological properties of a conventional proprietary high resolution thick film printing paste measured on the same instrument.

For displays work cathode tracks are typically screen printed onto suitable conducting films such as gold upon a glass substrate. Said films may be deposited by vacuum evaporation, sputtering or directly screen printed using so the called resinate or bright gold inks—see the Applicant's patent GB 2 330 687. Said printing is generally performed using a 400 mesh stainless steel screen with an approximately 13 micrometre thick emulsion layer.

After the substrates have been printed they are transferred to hotplates under the following conditions: a) 10 minutes at 50° C.−measured surface temperature of hotplate; b) 10 minutes at 120° C.−measured surface temperature of hotplate. The substrates are then transferred to an oven (air atmosphere) according to the following profile: ambient to 450° C. at 10° C./min; isotherm at 450° C. for 120 minutes; followed by cooling naturally to room temperature.

Post-cure treatments such as gentle ultrasonic cleaning or tacky rollers maybe used to remove any loose particles.

FIG. 14a, wherein the emitter patches are bright and dimension 1400 is 500 micrometre, shows an example of simulated pixel patches printed using the inks described herein FIG. 14b wherein the emitter patches are bright and dimension 1401 is 300 micrometre and dimensions 1402 and 1403 are ^{˜}60 micrometre, shows an example of fine feature printing for, say, a colour pixel triad.

The flatness of the finished film is an important parameter, as it affects the ease by which subsequent structures, such as gates, can be built upon the emitter layer. The best examples of the inks described herein produce layers with an average roughness of ^{˜}140 nm with a root mean square value of ^{˜}70 nm when measured using a Burleigh Horizon non-contact optical profilometer using a ×10 Mirau objective.

In FIGS. 15a and 15b, we see how printing and emitting properties maybe adjusted by controlling the porosity of the substrate. FIG. 15a shows a substrate 1501 with porous layer 1502 on top of which is a just-printed CHTR emitter ink layer 1503 with conducting particles 1504. The applicant has found that the best emission is obtained when the insulator film thickness over the particles is a few tens of nanometres. During natural ding, surface tension thins the insulator precursor layer over the convex upper regions of the particles, leading to a desirable thinning process. However, there is a race between this natural thinning process and the drying of the film which, at a certain point, locks in the thickness so reached. Moving now to FIG. 15b, we can seen how this beneficial thinning process may be speeded up by the presence of the porous layer 1502 below the printed ink layer that wicks away some of the liquid component of the ink 1505 before it can dry. We have found reductions in emission threshold field of ^{˜}1.5 V/micrometre, using this approach.

The porous layer 1502 maybe beneficially formulated to have resistive properties and so serve the additional function of a ballast layer.

Using one of the previously mentioned examples to form the basis of a screen-printed and heat-cured cold cathode layer, FIG. 9a, wherein dimension 900 is 11.2 mm, shows its performance measured using an emission image. The cold cathode vas disposed as a 1 cm² circular disk on a gold coated borosilicate glass slide, and mounted 0.25 mm away from a tin oxide coated glass anode in a vacuum system. The voltage applied to the diode was varied under computer control, with images of the electron bombardment induced fluorescence on the tin oxide coated anode being viewed by a CCD camera. The overall site density was limited by the 1 mA current limit of the apparatus being used. Hence, the image necessarily shows the sites with the lowest threshold field for emission, giving an indication of the uniformity of sites of this nature. For clarity of view and to facilitate reproduction, the view in FIG. 9a is shown in reverse video—that is, original light spots against a dark background are shown in the figure as dark spots against a light background.

FIG. 9b shows a voltage-current characteristic for the same sample as above, measured using the same equipment used to record the image in FIG. 9a. It shows that a macroscopic field lower than 10 V/micrometre delivered more than 10 micro-amperes of current.

FIG. 11 shows another emission image for another one of the examples (again in reverse video). This had an extremely high site density in one portion of the disk, the overall emitting area again limited by the 1 mA equipment limit. Dimension 1101 is ^{˜}3 mm and the site density determined using image analysis software was ^{˜}27 000 cm⁻².

FIG. 10a is a frequency histogram of threshold field for forty-nine separately tested areas on a sample formulated using one of the previous examples. The data was obtained by using a 350 micrometres diameter probe scanned 50 micrometres above the surface of the sample in a computer-controlled vacuum test system. This probe test provides a statistical distribution of the threshold fields in an area defined by the 350 micrometres diameter probe. FIG. 10b is a similar frequency histogram of the same sample generated using a 35 micrometres diameter probe scanned 25 micrometres above the surface of the sample in the same test system.

FIG. 12 shows current maps generated using the same probes over two different areas of sample. In these images, light grey pixels indicate 100 nA current and black squares indicate less than 1 nA current. In the first case 1200, a 5 mm by 10 mm scanned area, measured using the 350 micrometres diameter probe, shows saturation at a macroscopic field of 15 V/micrometre. In the second part 1201, the 1 mm by 1 mm scanned area, measured using the 35 micrometres diameter probe, shows emission site structure at 26 V/micrometre commensurate with a site density of ^{˜}300 000 sites cm⁻².

The field electron emission current available from improved emitter materials such as are disclosed above maybe used in a wide range of devices including (amongst others): field electron emission display panels; lamps; high power pulse devices such as electron MASERS and gyrotrons; crossed-field microwave tubes such as CFAs; linear beam tubes such as klystrons; flash x-ray tubes; triggered spark gaps and related devices; broad area x-ray sources for sterilisation; vacuum gauges; ion thrusters for space vehicles and particle accelerators.

Examples of some of these devices are illustrated in FIGS. 8a, 8b and 8c.

FIG. 8a shows an addressable gated cathode as might be used in a field emission display. The structure is formed of an insulating substrate 500, cathode tracks 501, emitter layer 502, focus grid layer 503 electrically connected to the cathode tracks, gate insulator 504, and gate tracks 505. The gate tracks and gate insulators are perforated with emitter cells 506. A negative bias on a selected cathode track and an associated positive bias on a gate track causes electrons 507 to be emitted towards an anode (not shown).

The reader is directed to our patent GB 2 330 687 for further details of constructing Field Effect Devices.

The electrode tracks in each layer may be merged to form a controllable but non-addressable electron source that would find application in numerous devices.

FIG. 8b shows how the addressable structure 510 described above may joined with a glass fritt seal 513 to a transparent anode plate 511 having upon it a phosphor screen 512. The space 514 between the plates is evacuated, to form a display.

Although a monochrome display has been described, for ease of illustration and explanation, it will be readily understood by those skilled in the art that a corresponding arrangement with a three-part pixel may be used to produce a colour display.

FIG. 8c shows a flat lamp using one of the above-described materials. Such a lamp may be used to provide backlighting for liquid crystal displays, although this does not preclude other uses, such as room lighting.

The lamp comprises a cathode plate 520 upon which is deposited a conducting layer 521 and an emitting layer 522. Ballast layers as mentioned above (and as described in our other patent applications mentioned herein) may be used to improve the uniformity of emission A transparent anode plate 523 has upon it a conducting layer 524 and a phosphor layer 525. A ring of glass fritt 526 seals and spaces the two plates. The interspace 527 is evacuated.

The operation and construction of such devices, which are only examples of many applications of embodiments of this invention, will readily be apparent to those skilled in the art. An important feature of preferred embodiments of the invention is the ability to print an emitting pattern, thus enabling complex multi-emitter patterns, such as those required for displays, to be created at modest cost. Furthermore, the ability to print enables low-cost substrate materials, such as glass to be used; whereas micro-engineered structures are typically built on high-cost single crystal substrates. In the context of this specification, printing means a process that places or forms an emitting material in a defined pattern. Examples of suitable processes to print these inks are (amongst others): screen printing or offset lithography. If patterning is not required techniques such as wire roll coating (K-coaters) or blade coating may also be used.

Devices that embody the invention maybe made in all sizes, large and small. This applies especially to displays, which may range from a single pixel device to a multi-pixel device, from miniature to macro-size displays.

In this specification, the verb “comprise” has its normal dictionary meaning, to denote nonexclusive inclusion. That is, use of the word “comprise” (or any of its derivatives) to include one feature or more, does not exclude the possibility of also including further features.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, maybe combined in any combination, except combinations where at least some of such features and/or steps are mutually exclusive.

Each feature disclosed in this specification (including any accompanying claims, abstract and drawings), maybe replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A method of creating a field electron emission material, comprising the steps of:
a. printing upon a substrate an ink comprising:
i. a major component of fluid vehicle;
ii. a first minor component of electrically insulating material, either ready formed or provided within a precursor therefor; and
iii. a second minor component of electrically conductive particles: and
b. treating the printed ink to expel said major component and create said field electron emission material from said minor components on said substrate.

2. A method according to claim 1, wherein said substrate has an electrically conductive surface upon which said ink is printed.

3. A method according to claim 1 or 2, wherein said particles comprise graphite.

4. A method according to claim 1, 2 or 3, wherein said particles are predominantly acicular.

5. A method according to claim 1, 2 or 3, wherein said particles are predominantly lamelliform.

6. A method according to claim 1, 2 or 3, wherein said particles are predominantly equiaxed.

7. A method according to claim 1, 2 or 3, wherein said particles have a low amorphous content.

8. A method according to claim 1 or 2, wherein said particles comprise nanotubes of carbon or other materials.

9. A method according to claim 2 or to any of claims 3 to 8 together with claim 2, wherein said treatment of the printed ink is such that each of said particles has a layer of said electrically insulating material disposed in a first location between said conductive surface and said particle, and/or in a second location between said particle and the environment in which the field electron emission material is disposed, such that electron emission sites are formed at at least some of said first and/or second locations.

10. A method according to any of the preceding claims, wherein said particles are included within a mixture of a plurality of first particles together with a plurality of second particles of generally smaller dimensions than said first particles.

11. A method according to claim 10, wherein at least some of said second particles decorate said first particles.

12. A method according to claim 10 or 11, wherein at least some of said second particles are disposed in interstices defined between said first particles.

13. A method according to claim 10, 11 or 12, wherein said second particles comprise particles of at least two differing types.

14. A method according to any of claims 10 to 13, wherein some or all of said second particles are more equiaxed than said first particles.

15. A method according to any of claims 10 to 14, wherein some or all of said second particles are more acicular than said first particles.

16. A method according to any of claims 10 to 15, wherein said first particles comprise graphite and said second particles comprise carbon blacks.

17. A method according to any of claims 10 to 16, wherein said first particles comprise graphite and said second particles comprise fumed silica or Laponite.

18. A method according to any of claims 10 to 15, wherein said first particles comprise a resistive material and said second particles comprise graphite.

19. A method according to claim 18, wherein said first particles comprise silicon carbide.

20. A method according to any of claims 10 to 19, wherein said second particles have a higher BET surface area value than said first particles.

21. A method according to any of claims 10 to 20, wherein said second particles are more crystalline than said first particles.

22. A method according to any of the preceding claims, wherein said ink contains said precursor for said electrically insulating material and said treatment of the printed ink includes subjecting the printed ink to conditions in which said precursor is converted into said electrically insulating material around at least part of each of said conductive particles.

23. A method according to claim 22, wherein said conditions include heating.

24. A method according to any of claims 1 to 21, wherein said electrically insulating material is provided as a substantially ready-formed layer on each of said electrically conductive particles.

25. A method according to any of the preceding claims, including the preliminary step of mixing said minor components and adding them to said major component, thereby to form said ink.

26. A method of creating a solid, electrically insulating layer in a field emission device, comprising the steps of:
a. printing on a substrate an ink comprising:
i. a major component of fluid vehicle; and
ii. a minor component of electrically insulating material, either ready formed or provided within a precursor therefor: and
b. treating the printed ink to expel said major component and create said solid, electrically insulating layer from said minor component on said substrate.

27. A method according to claim 26, wherein said solid, electrically insulating layer is formed as a gate insulator.

28. A method according to any of the preceding claims, including said precursor for said electrically insulating material, said precursor being in the form of a sol-gel or polymer precursor.

29. A method according to claim 28, wherein said precursor is a silica sol-gel.

30. A method according to claim 28, wherein said precursor is an alumina sol-gel.

31. A method according to claim 28, wherein said precursor is a polysiloxane.

32. A method according to claim 28, wherein said precursor is a silsesquioxane polymer.

33. A method according to claim 32, wherein said silsesquioxane is selected from the group comprising β-chloroethylsilsesquioxane; hydrogensilsequioxane; and acetoxysilsesquioxane.

34. A method according to any of the preceding claims, wherein said electrically insulating material is selected from the group comprising amorphous silica; ormosils; amorphous alumina and Laponite.

35. A method according to any of the preceding claims, wherein said fluid vehicle comprises water.

36. A method according to any of the preceding claims, wherein said fluid vehicle comprises an organic solvent.

37. A method according to any of the preceding claims, wherein said fluid vehicle contains at least one additive to control the rheology of the ink.

38. A method according to claim 37, wherein said at least one additive includes at least one thickening agent.

39. A method according to claim 38, wherein said thickening agent comprises a fugitive soluble organic polymer.

40. A method according to claim 39, wherein said fugitive soluble organic polymer is selected from the group comprising poly(vinyl alcohol; ethyl cellulose; hydroxyethyl cellulose; carboxymethyl cellulose; methylhydroxypropyl cellulose; hydroxypropyl cellulose; xanthan gum; and guar gum.

41. A method according to claim 38, wherein said thickening agent comprises a non-fugitive material.

42. A method according to claim 41 and to any of claims 1 to 25, wherein said non-fugitive material is selected from the group comprising fumed silica; carbon blacks; and Laponite.

43. A method according to any of claims 37 to 42, comprising at least one further additive to control further properties of the ink.

44. A method according to claim 43, wherein said at least one further additive comprises at least one of an anti-foaming agent; a levelling agent; a vetting agent; a preservative; an air-release agent; a retarder, and a dispersing agent.

45. A method according to claim 44, wherein said anti-foaming agent is a fugitive material.

46. A method according to claim 45, wherein said fugitive material is selected from the group comprising butyl cellosolve; n-octanol; emulsions of organic polymers and organic metal-compounds; and silicone-free defoaming substances in alkylbenezene.

47. A method according to claim 44, wherein said anti-foaming agent is a non fugitive material.

48. A method according to claim 47, wherein said non-fugitive material comprises a silicone.

49. A method according to any of claims 44 to 48, wherein said dispersing agent is selected from the group comprising poly(vinyl alcohol; modified polyurethane in butylacetate, methoxypropylacetate and sec. butanol; modified polyacrylate in meythoxypropanol; polyethylene glycol mono(4-(1,1,3,3-tetramethylbutyl)phenyl)ether; and mineral oils.

50. A method according to claim 49, wherein said dispersing agent comprises a silicone oil.

51. A method according to any of claims 44 to 50, wherein said at least one further additive comprises at least one dispersing agent and at least one said minor component has an affinity for that dispersing agent.

52. A method according to any of claims 44 to 51, wherein said levelling agent is selected from the group comprising poly(vinyl) alcohol; fluorocarbon modified polyacrylate in sec. butanol; organically modified polysiloxane in isobutanol; and solvent-free modified polysiloxane.

53. A method according to any of claims 44 to 52, wherein said wetting agent is selected from the group comprising unsaturated polyamide and acid ester salt in xylene, n-butanol and monpropylenegylcol; and alkylol ammonium salt of a high molecular weight carboxylic acid in water.

54. A method according to any of claims 44 to 53, wherein said preservative is selected from the group comprising phenols and formaldehydes.

55. A method according to any of claims 44 to 54, wherein said air-release agent is selected from the group comprising silica particles and silicones.

56. A method according to any of claims 44 to 55, wherein said retarder is selected from the group comprising 1,2-propanediol and terpineol.

57. A method according to any of the preceding claims, wherein said printing comprises screen printing.

58. A method according to any of the preceding claims, wherein said printing comprises ink-jet printing.

59. A method according to any of claims 1 to 56, wherein said printing is selected from the group comprising offset lithography; pad printing; table coating and slot printing.

60. A method according to any of the preceding claims, wherein said substrate is porous and said step of treating the printed ink includes absorbing at least part of said fluid vehicle into said porous substrate.

61. A method according to any of the preceding claims, wherein said step of treating the printed ink causes the mean thickness of the insulator in the cured layer to be reduced to 10% or less of the thickness of the ink as printed.

62. A method according to any of the preceding claims, wherein said step of treating the printed ink causes the mean thickness of the insulator in the cured layer to be reduced to 5% or less of the thickness of the ink as printed.

63. A method according to any of the preceding claims, wherein said step of treating the printed ink causes the mean thickness of the insulator in the cured layer to be reduced to 1% or less of the thickness of the ink as printed.

64. A method according to any of the preceding claims, wherein said step of treating the printed ink causes the mean thickness of the insulator in the cured layer to be reduced to 0.5% or less of the thickness of the ink as printed.

65. A method according to any of the preceding claims, wherein said major component comprises at least 50% by weight of the ink.

66. A method according to any of the preceding claims, wherein said major component comprises at least 80% by weight of the ink.

67. A method according to any of the preceding claims, wherein said major component comprises at least 90% by weight of the ink.

68. A method according to any of the preceding claims, wherein said major component comprises at least 95% by weight of the ink.

69. A method according to any of the preceding claims, wherein the weight of the or each said minor component in total comprises less than 50% by weight of the ink.

70. A method according to any of the preceding claims, wherein the weight of the or each said minor component in total comprises less than 10% by weight of the ink.

71. A method according to any of the preceding claims, wherein the weight of the or each said minor component in total comprises less than 5% by weight of the ink.

72. A method according to any of the preceding claims, wherein the weight of the or each said minor component in total comprises less than 2% by weight of the ink.

73. A method according to any of the preceding claims, wherein the weight of the or each said minor component in total comprises less than 1% by weight of the ink.

74. An method of creating a field electron emission material, substantially as hereinbefore described with reference to the accompanying drawings.

75. A field electron emitter comprising field electron emission material that has been created by a method according to any of the preceding claims.

76. A field electron emission device comprising a field electron emitter according to claim 75, and means for subjecting said emitter to an electric field in order to cause said emitter to emit electrons.

77. Afield electron emission device according to claim 76, comprising a substrate with an array of patches of said field electron emitters, and control electrodes with aligned arrays of apertures, which electrodes are supported above the emitter patches by insulating layers.

78. A field electron emission device according to claim 77, wherein said apertures are in the form of slots.

79. Afield electron emission device according to any of claims 76 to 78, comprising a plasma reactor, corona discharge device, silent discharge device, ozoniser, an electron source, electron gun, electron device, x-ray tube, vacuum gauge, gas filled device or ion thruster.

80. A field electron emission device according to any of claims 76 to 79, wherein the field electron emitter supplies the total current for operation of the device.

81. A field electron emission device according to any of claims 76 to 80, wherein the field electron emitter supplies a starting, triggering or priming current for the device.

82. A field electron emission device according to any of claims 76 to 81, comprising a display device.

83. Afield electron emission device according to any of claims 76 to 81, comprising a lamp.

84. Afield electron emission device according to claim 83, wherein said lamp is substantially flat.

85. A field electron emission device according to any of claims 76 to 84, wherein said emitter is connected to an electric driving means via a ballast resistor to limit current.

86. A field electron emission device according to claims 77 and 85, wherein said ballast resistor is applied as a resistive pad under each said emitting patch.

87. A field electron emission device according to any of claims 76 to 86, wherein said emitter material and/or a phosphor is/are coated upon one or more one-dimensional array of conductive tracks which are arranged to be addressed by electronic driving means so as to produce a scanning illuminated line.

88. A field electron emission device according to claim 87, including said electronic driving means.

89. A field electron emission device according to any of claims 76 to 88, wherein said field emitter is disposed in an environment which is gaseous, liquid, solid, or a vacuum.

90. A field electron emission device according to any of claims 76 to 89, comprising a cathode which is optically translucent and is so arranged in relation to an anode that electrons emitted from the cathode impinge upon the anode to cause electro-luminescence at the anode, which electro-luminescence is visible through the optically translucent cathode.

91. A field electron emission device, substantially as hereinbefore described with reference to the accompanying drawings.
